(19) United States
(12) Patent Application Publication
(10) Pub. No.: US 2022/0357974 A1
(43) Pub. Date: Nov. 10, 2022

(54) CONTAINER CREATION IN A COMPUTING SYSTEM

(71) Applicant: Core Scientific Operating Company, Bellevue, WA (US)

(72) Inventors: Cesar Gomez, Cáceres (ES); Lito Bejarano Borrega Angel, San Vicente De Alcantara (badajoz) (ES)

(21) Appl. No.: 17/738,635

(22) Filed: May 6, 2022

Related U.S. Application Data
(60) Provisional application No. 63/186,046, filed on May 7, 2021.

(51) Int. Cl. G06F 9/455; G06F 8/61; G06F 9/50

(52) U.S. Cl. CPC G06F 9/45558; G06F 8/63; G06F 9/5077; G06F 2009/45562; G06F 2009/4557; G06F 2209/505

(57) ABSTRACT

A method for providing container images in a distributed computing system is presented. The method includes the following: uploading a user Dockerfile via a management application; uploading Dockerfile metadata via the management application; providing the Dockerfile to a Docker container image builder to create a Docker container image; receiving, at an application store, the Docker container image from the Docker container image builder; providing the Dockerfile metadata to the application store; presenting, from the application store, the Docker container image; and providing, based on a user selection, the Docker container image to one of a plurality of third-party compute systems.

### CROSS-REFERENCE TO RELATED APPLICATION

This application claims the benefit of and priority to U.S. Provisional Patent Application Ser. No. 63/186,046, filed on May 7, 2021, the disclosure of which is hereby incorporated by reference in its entirety as though fully set forth herein

### TECHNICAL FIELD

The present disclosure generally relates to the field of computing and, more particularly, to systems and methods for efficiently creating and managing application container images in computing systems.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Data intensive computing tasks such as machine learning (ML), artificial intelligence (AI), data mining, and scientific simulation (often called workloads) frequently require large amounts of computing resources, including storage, memory, and computing power. As the time required for a single system or processor to complete many of these tasks would be too great, they are typically divided into many smaller tasks that are distributed to large numbers of computing devices or processors such as central processing units (CPUs) or graphics processing units (GPUs) within one or more computing devices (called nodes) that work in parallel to complete them more quickly. Specialized computing systems (often called clusters) have been built that offer large numbers of nodes that work in parallel have been designed complete these tasks more quickly and efficiently. Clusters can have different topologies (i.e., how compute resources are interconnected within a node or over multiple nodes). Groups of these specialized computing systems can be used together (both locally and remotely) to create large and complex distributed systems able to handle the highly complex computational workloads.

Properly setting up and configuring these computing systems can be difficult and time consuming for users. A typical end user may, for example, be a data scientist or artificial intelligence or machine learning specialist, not a systems engineer specializing in deployment. Unlike the simple process of downloading and installing an app on a phone or PC, in distributed computing systems the process is much more complex and time consuming. To run a machine learning experiment, a data scientist may have to first configure multiple different system parameters on many different nodes in the distributed system, including memory allocations, network connections, and storage. Then the data scientist must install the application to those nodes and configure the application so that it is aware of the topology the data scientist has configured with the nodes and network connections and ensure that the nodes are able to communicate with each other. This is a complex and time-consuming process, particularly for systems that incorporate many different nodes and interconnection types.

For at least these reasons, there is a desire for an improved system and method for efficiently creating and managing application instances in distributed computing systems.

### SUMMARY

An improved system and method for efficiently creating Docker container images is presented. According to an example, a method for providing container images in a distributed computing system includes: uploading a user Dockerfile via a management application; uploading container metadata via the management application; providing the Dockerfile to a Docker container image builder to create a Docker container image; receiving, at an application store, the Docker container image from the Docker container image builder; providing the container metadata to the application store; presenting, from the application store, the Docker container image; and providing, based on a user selection, the Docker container image to at least one of a plurality of third-party compute systems.

According to another example, a method includes: providing a user interface to a user to upload a Dockerfile; providing the uploaded Dockerfile to a Docker container image builder; receiving a Docker container image from the Docker container image builder, where the Docker container image is based on the Dockerfile; presenting the Docker container image at an application store; presenting user provided container metadata with the Docker container image at the application store; and allowing a plurality of third-party compute systems access to the Docker container image from the application store.

According to yet another example, a system includes: a management application configured to manage a plurality of compute systems for a plurality of users; a first user interface for a first user to upload a Dockerfile and container metadata; and an application. The application store is configured to: receive a Docker container image from a Docker container image builder; receive container metadata associated with the Dockerfile uploaded by the first user; and provide the Docker container image to at least one of the plurality of compute systems.

The above examples as well as other examples are described herein.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is an illustration of an exemplary distributed computing system;

FIG. 2 is an illustration of an exemplary workflow for creating a Docker container image;

FIG. 3A is an exemplary user interface for carrying out a container file search;

FIG. 3B is another exemplary user interface for carrying out a container file search;

FIG. 4A is an exemplary user interface for uploading a Dockerfile;

FIG. 4B is an exemplary user interface for reviewing metadata of a Dockerfile container image; and

FIG. 5 is an illustration of a technique for provider Docker container images to users.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

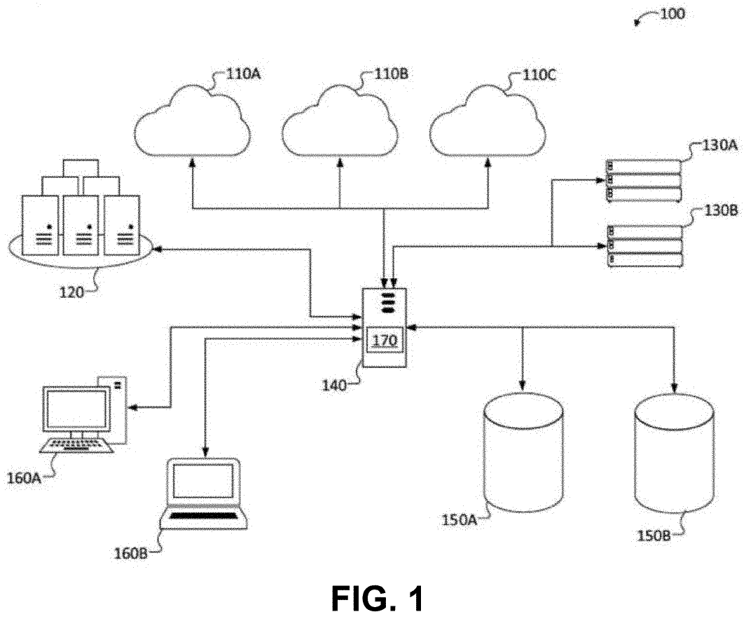

Turning now to FIG. 1, an exemplary distributed computing system 100 is shown. In this example, the distributed computing system 100 is managed by a management server 140, which may for example provide access to the distributed computing system 100 by providing a platform as a service (PAAS), infrastructure as a service (IAAS), or software as a service (SAAS) to users. Users may access these PAAS/IAAS/SAAS services from their network-connected PCs (160A) and laptop or mobile devices (160B) via a web interface.

Management server 140 is connected to a number of different computing devices via local or wide area network connections. This may include, for example, cloud computing providers 110A, 110B, and 110C. These cloud computing providers may provide access to large numbers of computing devices (often virtualized) with different configurations. For example, systems with one, two, four, eight, etc., virtual CPUs may be offered in standard configurations with predetermined amounts of accompanying memory and storage. In addition to cloud computing providers 110A, 110B, and 110C, management server 140 may also be configured to communicate with bare metal computing devices 130A and 130B (e.g., non-virtualized servers), as well as a datacenter 120 including for example one or more high performance computing (HPC) systems (e.g., each having multiple nodes organized into clusters, with each node having multiple processors and memory), and storage systems 150A and 150B. Bare metal computing devices 130A and 130B may for example include workstations or servers optimized for machine learning computations and may be configured with multiple CPUs and GPUs and large amounts of memory. Storage systems 150A and 150B may include storage that is local to management server 140 and well as remotely located storage accessible through a network such as the internet. Storage systems 150A and 150B may comprise storage servers and network-attached storage systems with non-volatile memory (e.g., flash storage), hard disks, and even tape storage.

Management server 140 is configured to run a distributed computing management application 170 that receives jobs and manages the allocation of resources from distributed computing system 100 to run them. In some embodiments, management server 140 may be a high-performance computing (HPC) system with many computing nodes, and management application 170 may execute on one or more of these nodes (e.g., master nodes) in the cluster.

Management application 170 is preferably implemented in software (e.g., instructions stored on a non-volatile storage medium such as a hard disk, flash drive, or DVD-ROM), but hardware implementations are possible. Software implementations of management application 170 may be written in one or more programming languages or combinations thereof, including low-level or high-level languages, with examples including Java, Ruby, JavaScript, Python, C, C++, C#, or Rust. The program code may execute entirely on the server 140, partly on server 140 and partly on other computing devices in distributed computing system 100.

The management application 170 provides an interface to users (e.g., via a web application, portal, API server or CLI command line interface) that permits users and administrators to submit jobs via their PCs/workstations 160A and laptops or mobile devices 160B, designate the data sources to be used by the jobs, configure containers to run the jobs, and set one or more job requirements (e.g., parameters such as how many processors to use, how much memory to use, cost limits, job priorities, etc.). This may also include policy limitations set by the administrator for the computing system 100.

Management server 140 may be a traditional PC or server, a specialized appliance, or one or more nodes within a cluster. Management server 140 may be configured with one or more processors, volatile memory and non-volatile memory such as flash storage or internal or external hard disk (e.g., network attached storage accessible to server 140).

Management application 170 may also be configured to receive computing jobs from user PC 160A and mobile devices/laptops 160B, determine which of the distributed computing system 100 computing resources are available to complete those jobs, select which available resources to allocate to each job, and then bind and dispatch the job to those allocated resources. In one embodiment, the jobs may be applications operating within containers (e.g. Kubernetes with Docker containers) or virtual machine (VM) instances.

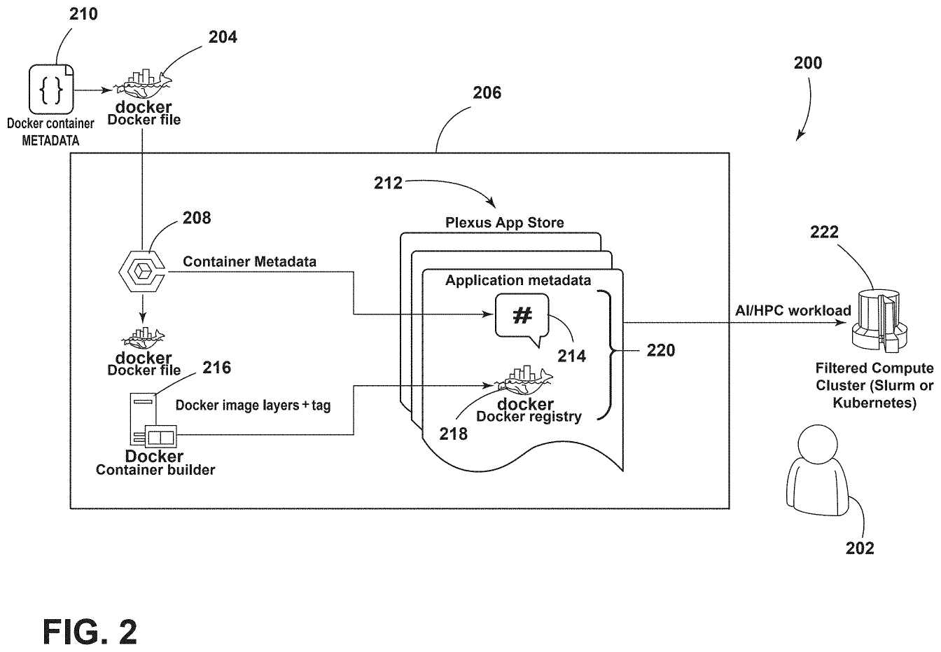

Turning now to FIG. 2, a schematic view of an exemplary workflow 200 for creating a docker application container is shown. A user 202 provides (e.g., uploads) a docker definition file 204 (Dockerfile) to a management application 206 (see, e.g., the management application 170 of FIG. 1) via an application programming interface 208 (API) as shown in FIG. 2. A Dockerfile is a text document that includes instructions which inform a Docker container image builder how a Docker image will be created. Unique Dockerfiles generally result in unique Docker images (Docker container). In addition to uploading the Dockerfile 204, the user may also provide or upload, via the API 208, metadata 210 associated with the Dockerfile 204. The metadata 210 may include, for example, VDC preferences, intended architecture (e.g., x86, ARM, CPUs, GPUs, or CPU) of the container that will be created, or even interconnect type, storage type(s), node specifications (number, memory, and CPU count), and/or data set types and names available.

Additional or alternative metadata may also be provided. For example, global container metadata may also be provided. A non-exhaustive list of exemplary global container metadata includes the following: number of input files, type of input files, number of output files, type of output files, data set types accepted, CPU architecture (including ISA extensions, if any), GPU architecture, input parameter specification (names, types, and ranges or enumerations), MPI version (e.g., a cached version of “mpirun-version”), network interconnect requirements, FPGA requirements, license, and minimum memory required.

Additionally, or alternatively, attribute metadata may also be provided such as, for example, cache size required, memory latency sensitivity, memory bandwidth sensitivity (may be in terms of typical usage), storage latency sensitivity, storage bandwidth sensitivity (as with memory bw), and/or other resource utilization (network, CPU execution units, and etc.). Further one or more of these attributes may be updated periodically from perf database analysis).

Pre-user container metadata may also be provided. For example, a non-exhaustive list of such metadata includes run script preferences and/or sort/filtering preferences for user interface (UI) (e.g., a favorites list or bookmarks).

Regardless of the type of metadata 210 provided, the API 208 provides the uploaded metadata 210 to an application store 212 (a.k.a., App Store) as container or application metadata 214.

In addition, the API 208 also provides the Dockerfile 204 to a Docker container image builder 216. A third-party container image builder may be employed to carry out the build or the management application 206 may carry out the build. Nonetheless, in turn, the Docker container image builder 216 builds and provides a Docker image, with its layers and tags, to the App Store 212 as a Docker registry 218 (a.k.a., a Docker container).

Accordingly, the App Store 212 includes the Docker Registry 218 and the container metadata 214, which may be sent as an application container image 220 to a third-party compute system 222 (e.g., a slurm or kubernetes cluster) so it may be deployed as an application container. The App Store 212 may be private (e.g., accessible to those with privileges at a particular organization) or public. Further, the App Store 212 may be configured to offer container images to a plurality of compute systems, not just the compute system 222 represented in FIG. 2.

Still further, the App Store 212 is configured to allow a user (e.g., user 202) to search for particular container images. For example, the App Store may be configured to operate on search terms presented by the user. In turn, the App Store 212 may then filter search results by employing the provided metadata (e.g., container metadata 214). In other words, based on a user's searched preferences, the App Store 212 may filter search results based on metadata to show generally those container images having attributes of the user's preferences.

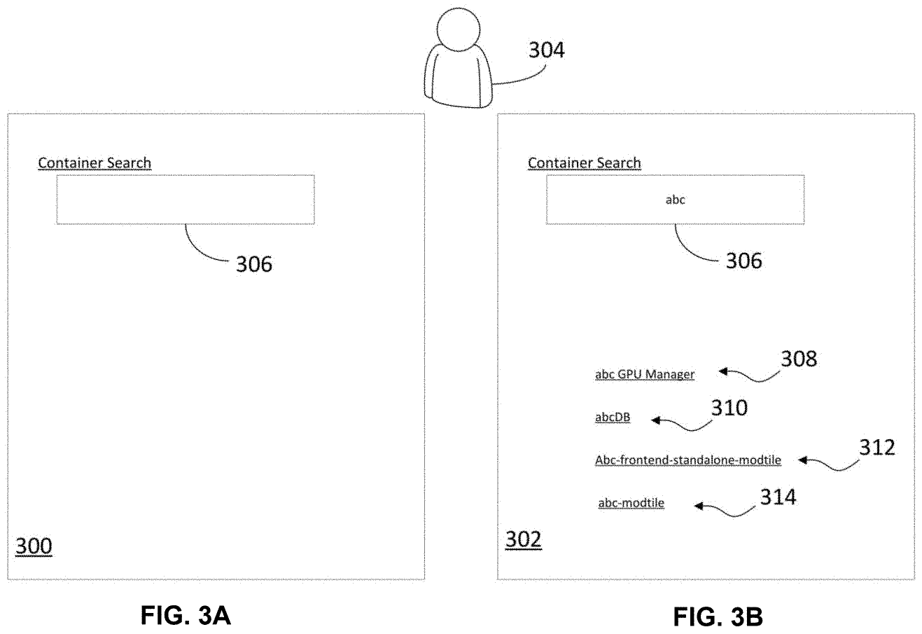

For example, FIGS. 3A and 3B represent exemplary search interfaces 300, 302 that may be employed by a user 304 to carry out a container image search. The first exemplary interface 300 of FIG. 3A illustrates a user search field 306. In the search field 306, the user 304 may input a variety of search terms according to the user's container-type preferences.

The second exemplary interface 302 of FIG. 3B illustrates an exemplary container-name (“abc”) search carried out by the user 304. The management application (e.g., management application 170 of FIG. 1) has filtered the results employing the container metadata (e.g., container metadata 214 of FIG. 2) to provide a plurality of search results 308-314 shown on the user interface of 302 of FIG. 3B. Accordingly, the plurality of search results 308-314 include some variation of the “abc” name. The user 304 may then choose the desired container image from the search results 308-314. While four search results 308-314 are represented in FIG. 3B, other examples may present less than four results or more than four results.

With reference to FIGS. 3A and 3B, the first and second interfaces 300, 302 are merely exemplary and other interfaces may instead be employed. Further, while the second interface 302 illustrates a “name search,” other types of metadata searches could instead be carried out by a user. Further, multiple metadata field-types could be employed by the user, thus providing more refined results. For example, in addition to the metadata discussed above, metadata such as container type, one or more application categories, container version, container architecture, an indication if replicas are allowed, a description, and/or whether or not the application is available as a service may also be employed to filter search results.

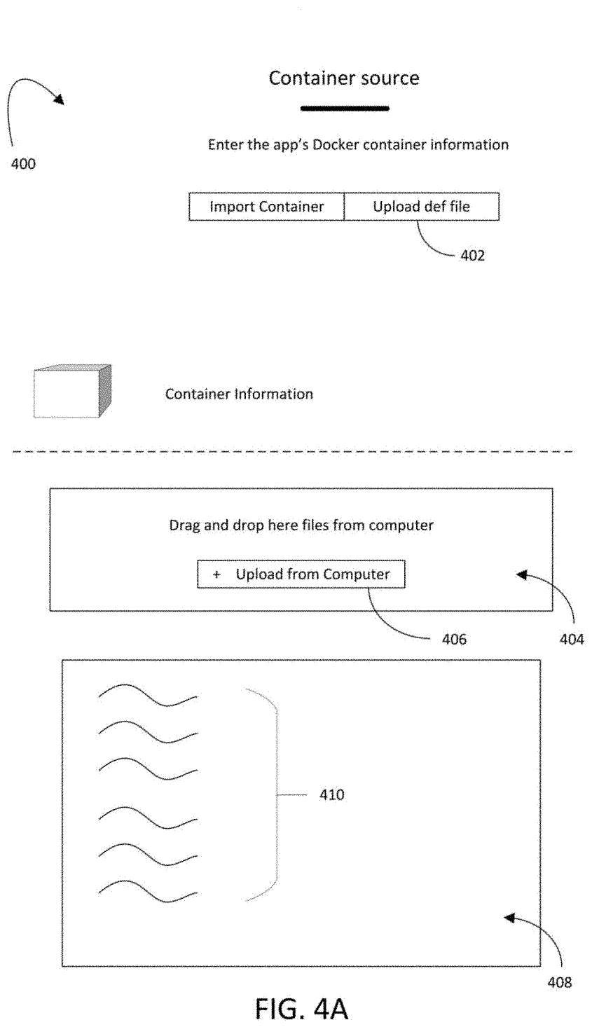

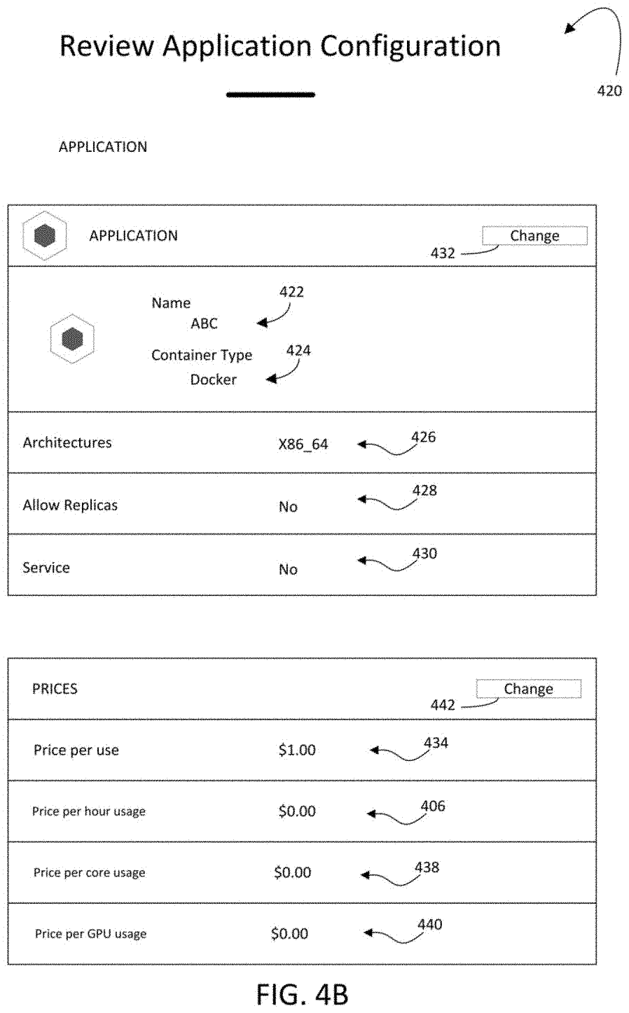

With reference now back to FIG. 2, the workflow 200 of FIG. 2 may be carried out via graphical user interfaces instead of at a command level of detail. For example, FIGS. 4A-4B represent a plurality of user interfaces that may be employed to create a Docker container image for an application that may be deployed at a later time.

An exemplary user interface 400 of FIG. 4A represents a user interface for at least uploading a Dockerfile (e.g., Dockerfile 204 of FIG. 2). An upload Dockerfile feature 402 (e.g., the “Upload def file” icon) shown in FIG. 4A can be selected by a user. The user may then select from two upload options. That is, the user may employ a drag and drop 404 method or select an upload feature 406 (i.e., select “Upload from Computer”) to upload the user's Dockerfile.

Upon selecting an upload option 404 or 406, the user Dockerfile is uploaded and presented in a viewing area 408. While FIG. 4A represents the Dockerfile as an abstraction 410, the Dockerfile may instead be presented as a text file in the viewing area 408. In some examples, the user may be offered the opportunity to make changes to the Dockerfile presented in the viewing area 408.

The Dockerfile may then be provided, either manually or automatically, to a Docker container image builder (see, e.g., Docker container image builder 216 of FIG. 2). The resulting Docker container image may then be presented, automatically or manually, to an application store (see, e.g., App Store 212 of FIG. 2).

In a similar manner to that which is set forth in FIG. 4A, a user may also employ a graphical user interface to upload metadata (see, e.g., the metadata container 214 of FIG. 2) to the application store.

Turning now to FIG. 4B, an additional exemplary user interface 420 where a user may review and make changes to the application container metadata is illustrated. As shown, a plurality of exemplary metadata fields 422-430, populated from previously uploaded metadata, is presented to the user. The metadata fields illustrated include an application name 422, a container type 424, an architecture type 426, an indication if replicas are allowable 428, and an indication if the container is offered as a service 430.

While only five metadata fields 422-430 are shown in FIG. 4B, other examples may present more or less metadata fields. Further, other exemplary interfaces may also present different types of metadata fields (e.g., number of input files, number of output files, CPU execution times, and etc.).

With continued reference to FIG. 4B, the user may review the metadata for accuracy. If the user would like to make a change, the user may select a change indicator 432. Accordingly, the use may provide a different metadata file to update any metadata field 422-430.

FIG. 4B also presents a plurality of fee rates 434-440. These fee rates 434-440 may be included in the uploaded metadata or determined in a different manner. A user may select a fee change indicator 442 to change one or more of the fee rates 434-440 presented.

By employing graphical user interfaces (e.g., the user interfaces 400, 420), the user can update or change Dockerfile metadata in an efficient manner.

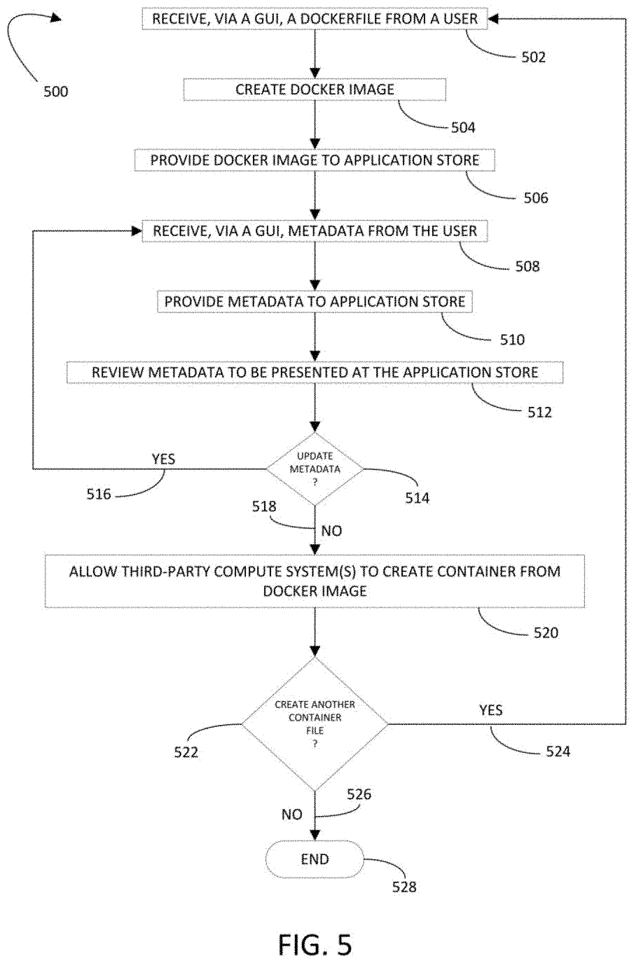

With reference now to FIG. 5, an exemplary technique 500 for providing Docker container images with metadata to users is shown. Technique begins at block 502, where a Dockerfile is received via a graphical user interface (GUI) from a user. Process control then proceeds to block 504 and a Docker container image is created. The Docker container image is created from the Dockerfile. The Docker container image may, for example, be created by a management application (see, e.g., the management application 170 of FIG. 1) or its creation may be outsourced to a third-party.

With continued reference to FIG. 5, the Docker container image is provided to an application store (see. e.g., the App Store 212 of FIG. 2) at block 506. Proceeding to block 508, metadata associated with the Dockerfile is received from the user via a GUI. The GUI employed to receive or upload (508) the metadata may be the same GUI employed to receive (502) the Dockerfile, or a different GUI may be employed. Nonetheless, at block 510, the metadata is automatically provided to the application store at block 510. The metadata may take the form of a metadata container file.

The metadata to be presented in the application store may be reviewed at block 512 and at block 514 it is determined if the metadata is to be updated. The user, may, for example, make that determination. If the metadata is to be updated 516, process control proceeds to block 508 where updated metadata is provided by the user to the GUI as technique 500 continues.

On the other hand, if metadata is not to be updated 518, process control proceeds to block 520 and third-party compute systems are allowed to create a container from the container image (a.k.a., application container image). While not shown, the application store may present the Docker container image and at least portions of the metadata to one or more users for selection. For example, the container image and metadata may be provided to the public, a private group, or individual. The user(s) may then select the container image, based on the metadata, for deployment on one or more third-party compute systems.

Regardless of whom the container image is presented too, process control proceeds to block 522 to determine if the user (i.e., the user that uploaded the Dockerfile and metadata) intends to upload another Dockerfile. If the user decides to upload 524 another container image, process control proceeds to back to block 502 where another container image may be uploaded as technique 500 repeats. Alternatively, the user decides not to upload 526 another container image, process control proceeds to block 528 and technique 500 comes to an end.

It is noted that in other exemplary techniques, action blocks may be rearranged. For example, while technique 500 illustrates that the Dockerfile is received (502) prior to the metadata being received (508), other techniques may instead receive the metadata before the Dockerfile, or each could be received at substantially the same time. As another example, the container image need not be provided 506 to the application store before the metadata is provided 510 to the application store. Still further, review 512 of the metadata may occur before the metadata is received at the application store. Other alternatives not discussed also exist.

The technique 500 of FIG. 5, among other techniques and systems discussed herein, provide an efficient and graphical manner in which a user may create a Docker container image. Further, the techniques and systems provide an efficient manner of other users to search for container images on an application store and, in turn, cause selected container images to be deployed on multiple compute systems. Due to the nature of container images, a user can deploy different container images to serve as application containers on differing compute systems. For example, in the past, if a user wanted to carry out scientific modeling, the user may have needed to fine-tune a modeling application for each compute system employed to ensure consistent and repeatable results across differing compute systems. However, by employing the techniques and systems described herein, a user need not fine-tune its modeling application for each compute system employed. Rather, the user can create container images (e.g., a Docker containers) for its application. That is, a container image for each differing compute system can be efficiently created. As such, differing container files can be provided to differing compute systems, where each compute system can operate the modeling application in the respective container. By employing containers, consistent results are generally ensured. Further, since the techniques and systems described herein allow for easy container image creation, the time-consuming task of modifying applications can be avoided since container image creation often is much faster.

While a modeling application was presented above as an example, it will be appreciated that other scenarios will benefit from the techniques and systems described herein.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments. Similarly, the use of terms such as first, second, third and the like do not necessarily infer an order unless stated otherwise. Rather, such terms are generally used for identification purposes or as differentiators.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” and “for example” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method for providing container images in a distributed computing system, the method comprising:
uploading a user Dockerfile via a management application;
uploading Dockerfile metadata via the management application;
providing the Dockerfile to a Docker container image builder to create a Docker container;
receiving, at an application store, the Docker container image from the Docker container image builder;
providing the Dockerfile metadata to the application store;
presenting, from the application store, the Docker container image; and
providing, based on a user selection, the Docker container image to at least one of a plurality of third-party compute systems.

2. The method of claim 1 further comprising presenting, from the application store at least a portion of the Dockerfile metadata along with the Docker container image.

3. The method of claim 2 further comprising presenting a graphical user interface to the user so that at least a portion of the Dockerfile metadata can be reviewed by the user.

4. The method of claim 3 further comprising updating the Dockerfile metadata based on user input.

5. The method of claim 1 further comprising receiving at least one search term from a user, wherein each search term is associated with container image metadata.

6. The method of claim 5 further comprising presenting to the user at least one container image for selection based on the at least one search term.

7. The method of claim 1, wherein the Dockerfile metadata includes at least one of a computer architecture type and an indication if replicas are allowed.

8. The method of claim 1, wherein the plurality of third-party compute systems includes at least a plurality of computer clusters.

9. A method comprising:
providing a user interface to a user to upload a Dockerfile;
providing the uploaded Dockerfile to a Docker container image builder;
receiving a Docker container image from the Docker container image builder, wherein the Docker container image is based on the Dockerfile;
presenting the Docker container image at an application store;
presenting user provided Dockerfile metadata with the Docker container image at the application store; and
allowing a plurality of third-party compute systems access to the Docker container image from the application store.

10. The method of claim 9 further comprising presenting a user an interface to review the user provided Dockerfile metadata.

11. The method of claim 10 further comprising updating the user provided Dockerfile metadata based on user input prior to presenting the user provided Dockerfile metadata with the Docker container image at the application store.

12. The method of claim 9 presenting a user an interface to employ search terms to search for a Docker container image in the application store.

13. The method of claim 1 filtering search term results based on user provided search terms and the user provided Dockerfile metadata.

14. The method of claim 9, wherein the user provided metadata includes at least one of a GPU identifier and a CPU identifier to identify container requirements.

15. A system comprising:
a management application configured to manage a plurality of compute systems for a plurality of users;
a first user interface for a first user to upload a Dockerfile and Dockerfile metadata; and
an application store configured to:
receive a Docker container image from a Docker container image builder;
receive container metadata associated with the Dockerfile metadata uploaded by the first user; and
provide the Docker container image to at least one of the plurality of compute systems.

16. The system of claim 15, wherein the plurality of compute systems includes a plurality of computer clusters.

17. The system of claim 16, the application store further configured to present the Docker container image and at least a portion of the container metadata to a plurality of users.

18. The system of claim 17 further comprising a container search interface configured to:
receive at least one search term from a second user; and
provide the second user at least one container image search result based on the at least one search term and the Dockerfile metadata.

19. The system of claim 17, wherein the Dockerfile metadata includes at least one of a computer architecture type and an indication if replicas are allowed.

20. The system of claim 19 further comprising a review interface configured to allow the first user to review the Dockerfile metadata prior to its presentation at the application store.
